(19) United States
(12) Patent Application Publication
(10) Pub. No.: US 2004/0071182 A1
(43) Pub. Date: Apr. 15, 2004

(54) Thermometry probe calibration method

(75) Inventors: David E. Quinn, Weedsport, NY (US); Kenneth J. Burdick, Skaneateles, NY (US); Ray D. Stone, San Diego, CA (US); John Lane, Weedsport, NY (US); William N. Cuipylo, Auburn, NY (US)

Correspondence Address: WALL MARJAMA & BILINSKI, 101 SOUTH SALINA STREET, SUITE 400, SYRACUSE, NY, 13202, US

(73) Assignee: Welch Allyn, Inc.

(21) Appl. No.: 10/269,461

(22) Filed: Oct. 11, 2002

(51) Int. Cl. G01K 15/00

(52) U.S. Cl. 374/1; 374/208

(57) ABSTRACT

A method in which thermal mass and manufacturing differences are compensated for in thermometry probes by storing characteristic data relating to individual probes into an EEPROM for each probe which is used by the temperature apparatus.

### FIELD OF THE INVENTION

This invention relates to the field of thermometry, and more particularly to a method of calibrating temperature measuring probes for use in a related apparatus.

### BACKGROUND OF THE INVENTION

Thermistor sensors in thermometric devices have typically been ground to a certain component calibration which will affect the ultimate accuracy of the device. These components are then typically assembled into precision thermometer probe assemblies.

In past improvements, static temperature measurements or “offset type coefficients” have been stored into the thermometer's memory so that they can be added or subtracted before a reading is displayed by a thermometry system, thereby increasing accuracy of the system.

A problem with the above approach is that most users of thermometry systems cannot wait the full amount of time for thermal equilibrium, which is typically where the offset parameters are taken.

Predictive thermometers look at a relatively small rise time (e.g., approximately 4 seconds) and thermal equilibrium is typically achieved in 2-3 minutes. A prediction of temperature, as opposed to an actual temperature reading, can be made based upon this data.

A fundamental problem with current thermometry systems is the lack of accounting for variations in probe construction/manufacturing which would affect the quality of the early rise time data. A number of factors, for example, the mass of the ground thermistor, amounts of bonding adhesives/epoxy, thicknesses of the individual probe layers, etc. will significantly affect the rate of temperature change which is being sensed by the apparatus. To date, there has been no technique utilized in a predictive thermometer apparatus for normalizing these effects.

Another effect relating to certain thermometers includes pre-heating the heating element of the thermometer probe prior to placement of the probe at the target site. Such thermometers, for example, as described in U.S. Pat. No. 6,000,846 to Gregory et al., the entire contents of which is herein incorporated by reference allow faster readings to be made by permitting the heating element to be raised in proximity (within about 10 degrees or less) of the body site. The above manufacturing effects also affect the preheating and other characteristics on an individual probe basis. Therefore, another general need exists in the field to also normalize these effects for preheating purposes.

### SUMMARY OF THE INVENTION

It is a primary object of the present invention to attempt to alleviate the above-described problems of the prior art.

It is another primary object of the present invention to normalize the effects of different temperature probes for a thermometry apparatus.

Therefore and according to a preferred aspect of the present invention, there is disclosed a method for calibrating a temperature probe for a thermometry apparatus, said method including the steps of:

characterizing the transient heat rise behavior of a said temperature probe; and

storing characteristic data on an EEPROM associated with each said probe.

Preferably, the stored data can then be used in an algorithm(s) in order to refine the predictions from a particular temperature probe.

According to another preferred aspect of the present invention, there is disclosed a method for calibrating a temperature probe for a thermometry apparatus, said method comprising the steps of:

characterizing the preheating characteristics of a temperature probe; and

storing said characteristic data on an EEPROM associated with each probe.

Preferably and in each of the above aspects of the invention, the characteristic data which is derived is compared to that of a “nominal” temperature probe. Based on this comparison, adjusted probe specific coefficients can be stored into the memory of the EEPROM for use in a polynomial(s) used by the processing circuitry of the apparatus.

An advantage of the present invention is that the manufacturing effects of various temperature probes can be easily normalized for a thermometry apparatus.

These and other objects, features and advantages will become readily apparent from the following Detailed Description which should be read in conjunction with the accompanying drawings.

### BRIEF DESCRIPTION OF THE DRAWINGS

FIG. 1 is a top perspective view of a temperature measuring apparatus used in accordance with the method of the present invention;

FIG. 2 is a partial sectioned view of the interior of a temperature probe of the temperature measuring apparatus of FIG. 1;

FIG. 3 is an enlarged view of a connector assembly for the temperature probe of FIGS. 1 and 2, including an EEPROM used for storing certain thermal probe related data;

FIGS. 4 and 5 are exploded views of the probe connector of FIG. 3;

FIG. 6 is a graphical representation comparing the thermal rise times of two temperature probes; and

FIG. 7 is a graphical representation comparing the preheating characteristics of two temperature probes.

### DETAILED DESCRIPTION

The following description relates to the calibration of a particular thermometry apparatus. It will be readily apparent that the inventive concepts described herein are applicable to other thermometry systems and therefore this discussion should not be regarded as limiting.

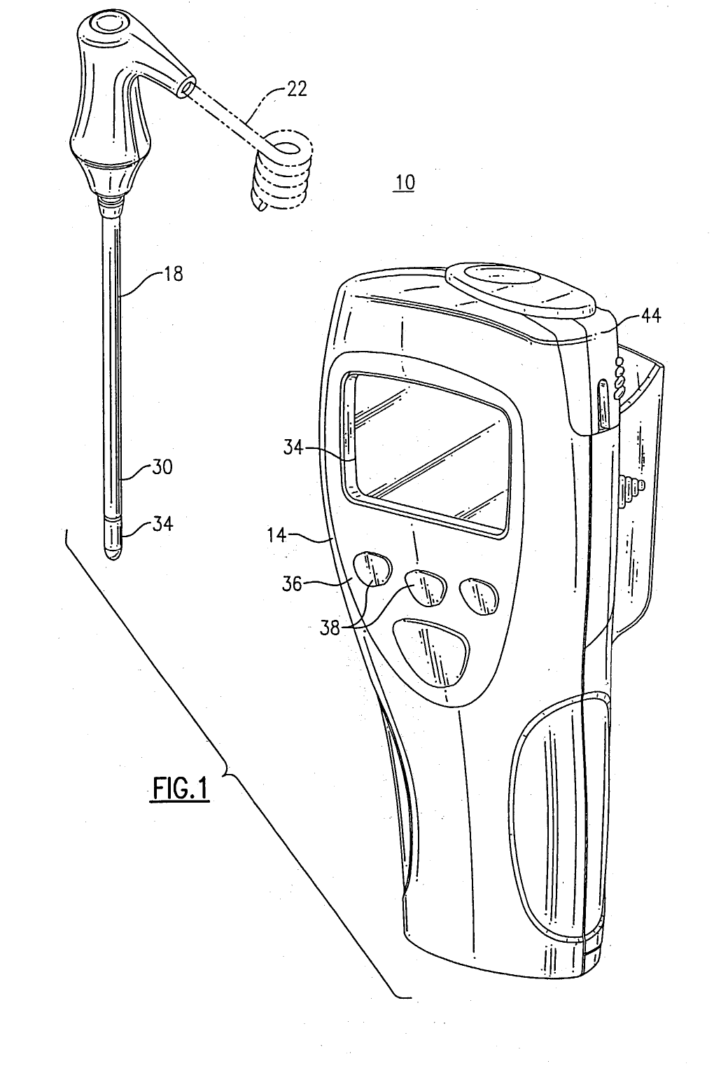

Referring first to FIG. 1, there is shown a temperature measuring apparatus 10 that includes a compact housing 14 and a temperature probe 18 which is tethered to the housing by means of a flexible electrical cord 22, shown only partially and in phantom in FIG. 1. The housing 14 includes a user interface 36 which includes a display 34 as well as a plurality of actuable buttons 38 for controlling the operation of the apparatus 10. The apparatus 10 is powered by means of batteries (not shown) that are contained within the housing 14. As noted, the temperature probe 18 is tethered to the housing 14 by means of the flexible cord 22 and is retained within a chamber 44 which is releasably attached thereto. The chamber 44 includes a receiving cavity and provides a fluid-tight seal with respect to the remainder of the interior of the housing 14 and is separately described in copending and commonly assigned U.S. Ser. No. (to be assigned) (Attorney Docket 281_{—}394), the entire contents of which are herein incorporated by reference.

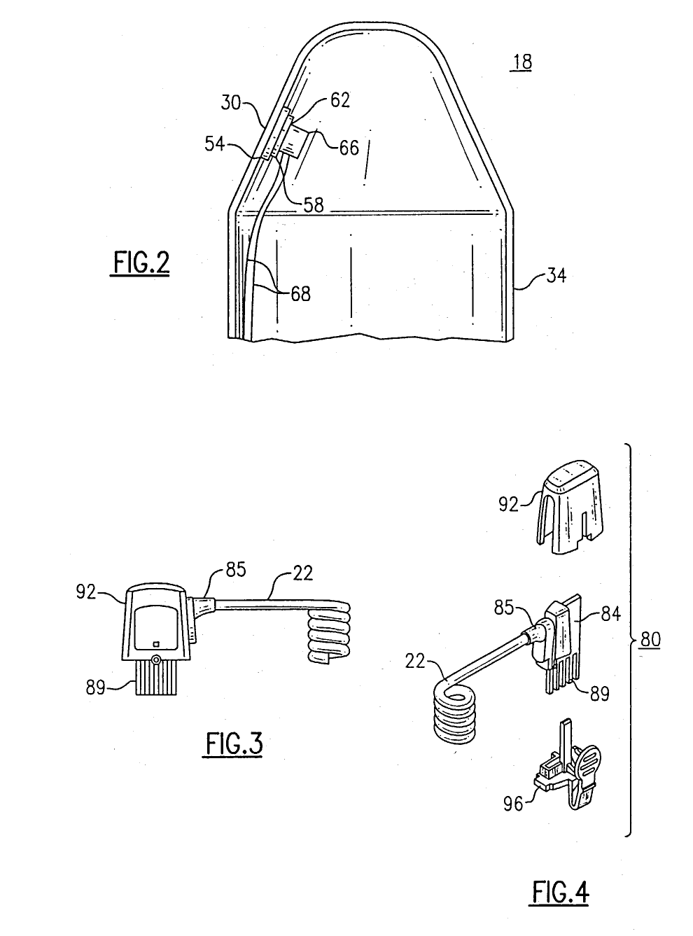

Turning to FIG. 2, the temperature probe 18 is defined by an elongate casing 30 which includes at least one temperature responsive element that is disposed in a distal tip portion 34 thereof, the probe being sized to fit within a patient body site (e.g., sublingual pocket, rectum, etc.,).

The manufacture of the temperature measuring portion of this probe 18 includes several layers of different materials. The disposition and amount of these materials significantly influences temperature rise times from probe to probe and need to be taken into greater account, as is described below. Still referring to the exemplary probe shown in FIG. , 2, these layers include (as looked from the exterior of the probe 18) the outer casing layer 30, typically made from a stainless steel, an adhesive bonding epoxy layer 54, a sleeve layer 58 usually made from a polyimide or other similar material, a thermistor bonding epoxy layer 62 for applying the thermistor to the sleeve layer, and a thermistor 66 which serves as the temperature responsive element disposed in the distal tip portion 34 of the thermometry probe 18. As noted above and in probe manufacture, each of the above layers will vary significantly (as the components themselves are relatively small). In addition, the orientation of the thermistor 66 and its own inherent construction (e.g., wire leads, solder pads, solder, etc.) will also vary from probe to probe. The wire leads 68 extending from the thermistor 66 extend from the distal tip portion of the probe 18 to the cord 22 in a manner commonly known in the field.

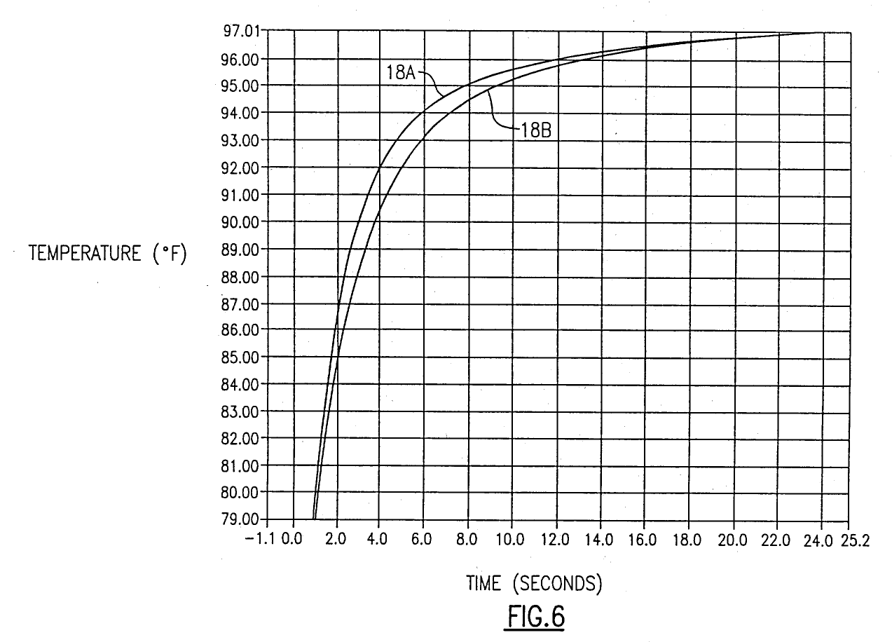

A first demonstration of these differences is provided by the following test which was performed on a pair of temperature probes 18A, 18B, as described above. These probes were tested and compared using a so-called “dunk” test. Each of the probes were tested using the same probe cover (not shown). In this particular test, each temperature probe is initially lowered into a large tank (not shown) containing a fluid (e.g., water) having a predetermined temperature and humidity. In this instance, the water had a temperature comparable to that of a suitable body site (ie., 98.6 degrees Fahrenheit). Each of the probes were separately retained within a supporting fixture (not shown) and lowered into the tank. A reference probe (not shown) monitored the temperature of the tank which was sufficiently large so as not to be significantly effected by the temperature effects of the probe. As is apparent from the graphical representation of time versus temperature for each of the probes 18A, 18B compared in FIG. 6, each of the temperature probes ultimately reaches the same equilibrium temperature; however, each probe takes a differing path. It should be pointed out that other suitable tests, other than the “dunk” test described herein, can be performed to demonstrate the effect shown according to FIG. 6.

With the previous explanation serving as a need for the present invention, it would be preferred to be able to store characteristic data relating to each probe, such as data relating to transient rise time, in order to normalize the manufacturing effects that occur between individual probes. As previously shown in FIG. 1, one end of the flexible electrical cord 22 is attached directly to a temperature probe 18, the cord including contacts for receiving signals from the contained thermistor 66 from the leads 68.

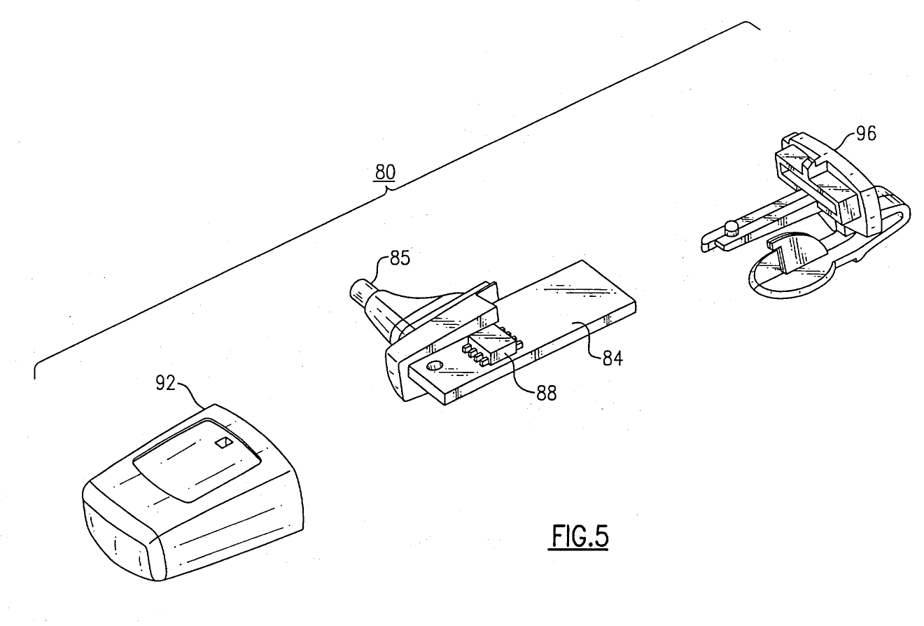

Referring to FIGS. 3-5, a construction is shown for the opposite or device connection end of the flexible electrical cord 22 in accordance with the present invention. This end of the cord 22 is attached to a connector 80 that includes an overmolded cable assembly 82 including a ferrule 85 for receiving the cable end as well as a printed circuit board 84 having an EEPROM 88 attached thereto. The connector 80 further includes a cover 92 which is snap-fitted over a frame 96 which is in turn snap-fitted onto the cable assembly 82. As such, the body of the EEPROM 88 is shielded from the user while the programmable leads 89 extend from the edge and therefore become accessible for programming and via the housing 14 for input to the processing circuitry when a probe 18 is attached thereto. The frame 96 includes a detent mechanism, which is commonly known in the field and requires no further discussion, to permit releasable attachment with an appropriate mating socket (not shown) on the housing 14 and to initiate electrical contact therewith.

During assembly/manufacture of the probe 18 and following the derivation of the above characteristic data, the stored values such as those relating to transient rise time are added into the memory of the EEPROM 88 prior to assembly into the probe connector 80 through access to the leads extending from the cover 92. These values can then be accessed by the housing processing circuitry when the connector 80 is attached to the housing 14.

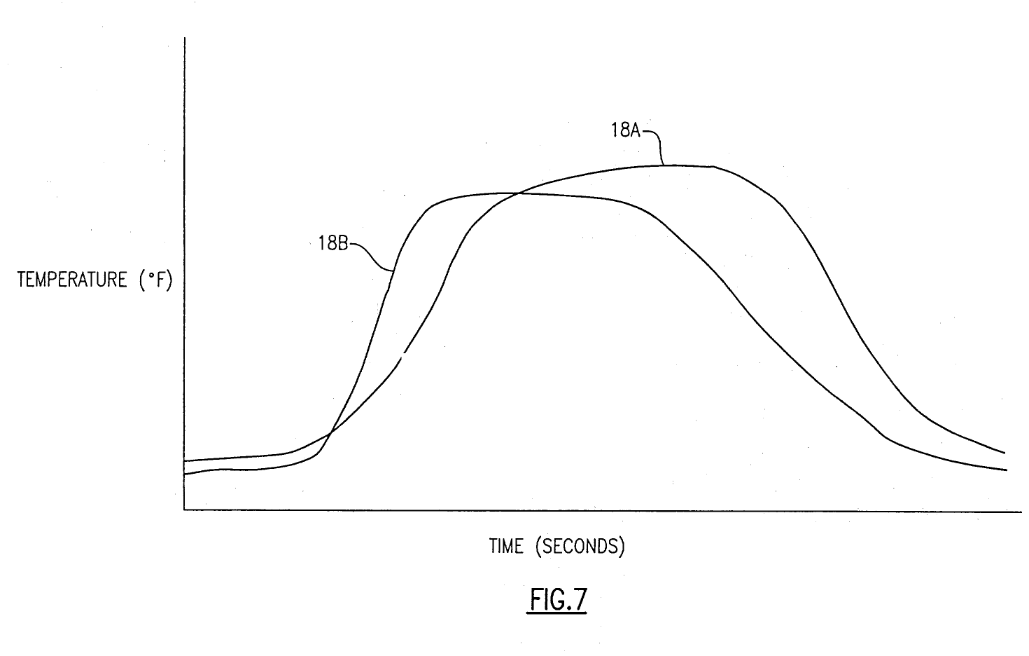

Additional data can be stored onto the EEPROM 88. Referring to FIG. 7, a further demonstration is made of differing characteristics between a pair of temperature probes 18A, 18B. In this instance, the heating elements of the probes are provided with a suitable voltage pulse and the temperature rise is plotted versus time. The preheating efficiency of each probe 18A, 18B can then be calculated by referring either to the raw height of the plotted curve or alternately by determining the area under the curve. In either instance, the above described variations in probe manufacturing can significantly affect the preheating character of the probe 18A, 18B and this characteristic data can be utilized for storage in the EEPROM 88.

In either of the above described instances, one of the probes 18A, 18B being compared is an ideal or so-called “nominal” thermometry probe having an established profiles for the tests (transient heat rise, preheating or other characteristic) being performed. The remaining probe 18B, 18A is tested as described above and the graphical data between the test and the nominal probe is compared. The differences in this comparison provides an adjustment(s) which is probe-specific for a polynomial(s) used by the processing circuitry of the apparatus 10. It is these adjusted coefficients which can then be stored into the programmable memory of the EEPROM 88 via the leads 89 to normalize the use of the probes with the apparatus.

Parts List for FIGS. 1-7

10 temperature measuring apparatus

14 housing

18 temperature probe

18A temperature probe

18B temperature probe

22 flexible cord

30 casing

34 distal tip portion

54 bonding epoxy layer

58 sleeve layer

62 thermistor epoxy layer

66 thermistor

68 leads

80 connector

82 cable assembly

84 printed circuit board

85 ferrule

88 EEPROM

89 leads

92 cover

96 frame

We claim:

1. A method for calibrating a temperature probe for a thermometry apparatus, said method comprising the steps of:
characterizing the transient heat rise behavior of a temperature probe used with said apparatus; and
storing characteristic data on an EEPROM associated with each probe.

2. A method as recited in claim 1, including the step of applying the stored characteristic data to an algorithm for predicting temperature.

3. A method as recited in claim 3, including the steps of comparing the characteristic data of a said temperature probe to that of a nominal temperature probe and normalizing said characteristic data based on said comparison prior to said applying step.

4. A method for calibrating a temperature probe for a thermometry apparatus, said method comprising the steps of:
characterizing the preheating data of a temperature probe used with said apparatus; and
storing said characteristic preheating data on an EEPROM associated with said apparatus.

5. A method as recited in claim 4, including the step of applying the stored characteristic preheating data into an algorithm for preheating the probe to a predetermined temperature.

6. A method as recited in claim 5, including the steps of comparing the preheating characteristics of a said temperature probe to that of a nominal temperature probe and normalizing said characteristic data based on said comparison prior to said applying step.
